(19) United States
(12) Patent Application Publication
(10) Pub. No.: US 2004/0013074 A1
(43) Pub. Date: Jan. 22, 2004

(54) Multi-layered optical information storage medium and recording/reproducing method for the optical information storage medium

(75) Inventors: Kyung-geun Lee, Gyeonggi-do (KR); In-sik Park, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-City (KR)

(21) Appl. No.: 10/434,485

(22) Filed: May 9, 2003

(30) Foreign Application Priority Data
May 31, 2002 (KR) 2002-30610

(51) Int. Cl. G11B 7/20

(52) U.S. Cl. 369/94; 369/275.3; 369/283

(57) ABSTRACT

An optical information storage medium includes information on recording layers that have the same reproduction channel characteristics or different reproduction channel characteristics, and a recording/reproducing method for the optical information storage medium. Formal recording layer information is recorded in a reproduction-only zone, and effective recording layer information is recorded in a recordable zone of the area other than a user data area. The formal recording layer information is reproduced using a differential signal channel or a sum channel, and the effective recording layer information is reproduced using the sum channel. The optical information storage medium addresses the case that all of recording layers cannot satisfy the formal recording layer information due to errors occurring during the manufacture of a storage medium. Thus, the disc defective proportion can be reduced, and loss of user data due to application of inaccurate recording layer information can be prevented.

### CROSS-REFERENCE TO RELATED APPLICATIONS

This application claims the benefit of Application No. 2002-30610, filed May 31, 2002, in the Korean Intellectual Property Office, the disclosure of which is incorporated herein by reference.

### BACKGROUND OF THE INVENTION

1. Field of the Invention

The present invention relates to a multi-layered optical information storage medium and a recording/reproducing method therefor, and more particularly, to a multi-layered optical information storage medium in which information on recording layers that have the same reproduction channel characteristics or different reproduction channel characteristics is recorded, and a recording/reproducing method for the multi-layered optical information storage medium.

2. Description of the Related Art

Optical discs, which are optical information storage media, are widely used in optical pickup devices that record/reproduce information in a non-contact manner. Types of optical discs are compact discs (CD), digital versatile discs (DVD), and high density DVDs (HD-DVD). Optical discs capable of recording, erasing, and reproducing data are CD-R, CD-RW, DVD-RW, DVD-RAM, DVD+RW, or the like.

With an increase in the recording density of such optical discs, the number of recording layers in the discs increases. When such a multi-layered disc is manufactured and then its features are checked, only some recording layers may satisfy standard recording characteristics due to problems caused during manufacturing. For example, in the case of a two-layer disc having first and second recording layers L0 and L1, only the first recording layer L0 may satisfy the standard recording characteristics. In this case, the second recording layer cannot be used, but the first recording layer can be used. Hence, the capacity of the dual layer disc is equal to that of a single-layered disc. If such a disc having a plurality of recording layers among which some cannot be used is abandoned as a defective disc, considerable manufacturing losses will occur. Therefore, even when all recording layers do not satisfy the predetermined recording characteristics, there is a need to find a method of utilizing recording layers that satisfy the recording characteristics.

### SUMMARY OF THE INVENTION

The present invention provides a multi-layered optical information storage medium having information on usable recording layers by recording information regarding recording layers using different channel characteristics or the same channel characteristics, recording, as reproduction-only data, recording layer information that is reproduced using a differential signal channel or a sum channel, and recording information on a recordable recording layer, the information that is reproduced using the sum channel in a recordable zone of the area other than a user data area.

The present invention also provides a multi-layered optical information storage medium having a plurality of recording layers, wherein formal recording layer information is recorded in a reproduction-only area, and effective recording layer information is recorded in a recordable zone of an area other than a user data area.

According to an aspect of the present invention, a multi-layered optical information storage medium includes a plurality of recording layers, wherein formal recording layer information is recorded in a reproduction-only area, and effective recording layer information is recorded in a recordable zone of an area other than a user data area.

In one implementation, the formal recording layer information is recorded as data that is reproduced using a differential signal channel. The data that is reproduced using a differential signal channel is recorded in a high-frequency wobble. The formal recording layer information is recorded in a pit that is reproduced using a sum channel.

The effective recording layer information may include data that is reproduced using a sum channel.

The multi-layered optical information storage medium may include a lead-in area, a user data are, and a lead-out area, and the effective recording layer information may be recorded in a rewritable data zone of at least one of the lead-in area and the lead-out area.

The effective recording layer information may be recorded as a recording layer flag or code using at least one bit or a bit combination of a predetermined byte in the rewritable data zone.

The effective recording layer information may be recorded in each of the bits of a byte present in the rewritable data zone in such a way that information on each of the recordable recording layers corresponds to each of the bits.

According to another aspect of the present invention, there is provided a method of recording/reproducing data in/from an optical information storage medium that is constituted of a lead-in area, a user data area, and a lead-out area and has a plurality of recording layers. In the method, formal recording layer information is recorded in a reproduction-only data zone of at least one of the lead-in area and the lead-out area. Effective recording layer information is recorded in a rewritable data zone of at least one of the lead-in area and the lead-out area. A disc drive recognizes the effective recording layer information, accesses an appropriate effective recording layer in accordance with the effective recording layer information, and records data in the accessed effective recording layer.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the present invention will become more apparent by describing in detail preferred embodiments thereof with reference to the attached drawings in which:

FIG. 1 illustrates the structure of a lead-in area of an optical information storage medium according to an embodiment of the present invention;

FIG. 2 illustrates part of the data structure of the optical information storage medium of FIG. 1;

FIG. 3 is a schematic view for explaining an optical information storage medium according to a first embodiment of the present invention and a recording/reproducing method therefor;

FIG. 4 is a schematic view for explaining an optical information storage medium according to a second embodiment of the present invention and a recording/reproducing method therefor; and

FIG. 5 is a block diagram illustrating a method of determining recordable recording layers in an optical information storage medium according to an embodiment of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

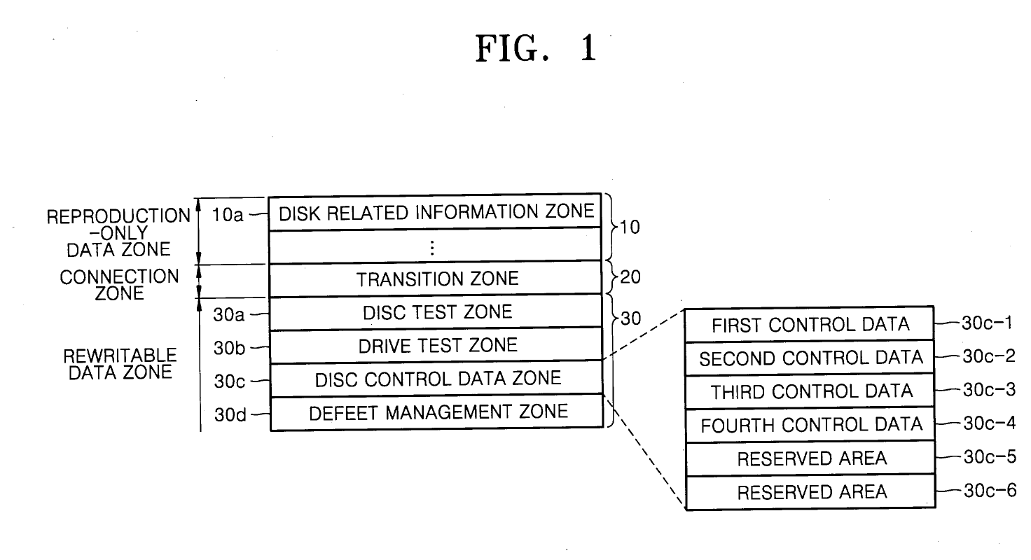

FIG. 1 schematically shows the structure of the lead-in area of an optical information storage medium including the lead-in area, a user data area, and a lead-out area. The lead-in area is formed of pits or in a high frequency wobble on the innermost circumference of the disc and includes a reproduction-only data zone 10, a connection zone 20, and a rewritable data zone 30. The reproduction-only data zone 10 contains the basic information on the disc.

The reproduction-only data zone 10 includes a disc information zone 10a that records the size of the disc, the version number of the disc, recording conditions, or the like. Information on the formal recording layers of a disc can also be recorded in the disc information zone 10a. The formal recording layer information of a disc denotes information regarding recording layers determined in a format that prescribes the disc. For example, the formal recording layer information may include media specifications such as the laser wavelength, reflectivity, modulation amplitude, tracking method, and scanning velocity. Formal recording layer information also may include information regarding the number of recording layers or which recording layer can be accessed by a pickup is recorded in the disc-related information zone 10a.

The formal recording layer information regarding a disc, which is reproduction-only data, can be recorded as a land pre-pit (LPP) or pit or recorded as a high-frequency wobble. In this respect, a high-frequency wobble signal is disclosed in Korean Patent Application No. 2001-023747 filed by the applicant of the present invention, and represents a wobble signal that has a relatively higher frequency than a wobble signal formed in a user data area.

Formal recording layer information recorded as a high-frequency wobble is reproduced using a differential signal channel ch2 that uses a push-pull signal. Formal recording speed information recorded in a pit is reproduced using a sum channel ch1. Upon data recording on a disc, the formal recording layer information for the disc recorded as described above is recognized by a disc drive, and then a pickup accesses and records data in a recordable layer.

The connection zone 20 can include a transition zone that connects the reproduction-only data zone 10 to the rewritable data zone 30. The connection zone 20 can be a mirror zone or can be a wobble groove area instead.

The rewritable data zone 30 can include a disc test zone 30a, a drive test zone 30b, a disc control data zone 30c, and a defect management zone 30d. The disc control data zone 30c includes at least one disc control area in which information regarding a disc control is recorded. For example, first through fourth disc control areas 30c-1, 30c-2, 30c-3, and 30c-4 are included. At least one reserved area, for example, two reserved areas 30c-5 and 30c-6, can be further included to record other information in the future.

Since the lead-out area has a similar structure to the lead-in area, the lead-out area will not be described in detail.

Ideally, an optical information storage medium must be able to record data in all recording layers according to the formal recording layer information recorded in the disc-related information zone 10a. However, in practice, due to errors occurring during the manufacture of the optical information storage medium, all recording layers may not satisfy the predetermined recording characteristics complying with the information regarding the formal recording layers of a disc. Hence, some recording layers may not record data. In this case, instead of the formal recording layer information, information regarding layers that are recordable and actually satisfies predetermined recording characteristics needs to be newly recorded. Hereinafter, the information regarding layers that are actually recordable is referred to as effective recording layer information.

In a recording/reproducing method for an optical information storage medium according to a first embodiment of the present invention, effective recording layer information is recorded in a recordable zone of the areas other than the user data area. For example, in an optical information storage medium that is constituted of a lead-in area, a user data area, and a lead-out area and includes a plurality of recording layers, information regarding recordable recording layers is recorded in the rewritable data zone of at least one of the lead-in area and the lead-out area. For example, effective recording layer information can be recorded in a predetermined area of the rewritable data zone 30. Here, effective recording layer information, which is data reproduced using the sum channel ch1, can be recorded in the same manner as data is recorded in the user data area.

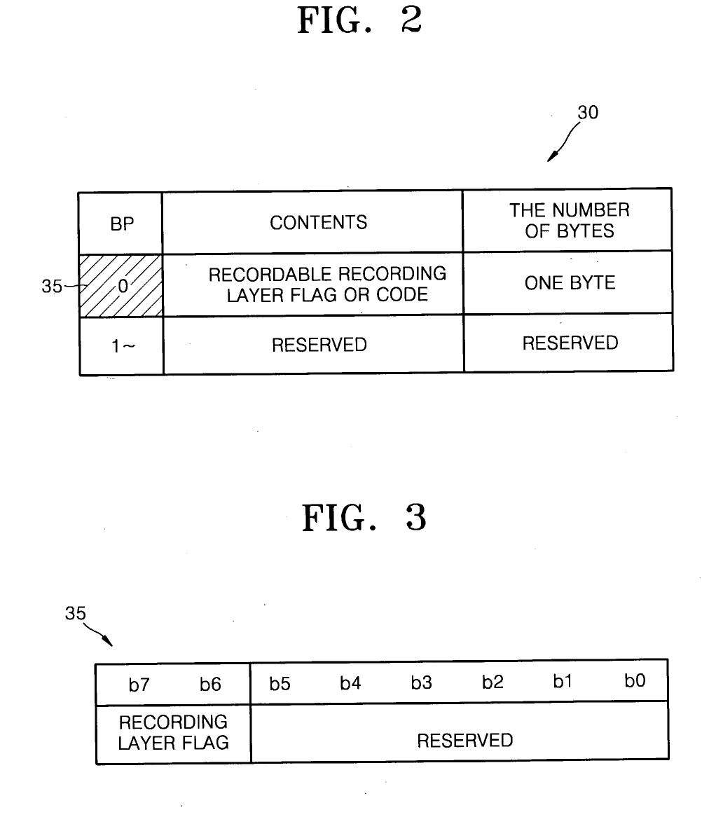

Referring to FIG. 2, the rewritable data zone 30 includes a plurality of bytes, and the effective recording layer information can be recorded in one byte among the plurality of bytes. For example, in the rewritable data zone 30, a recordable recording layer flag can be recorded using at least one bit existing at a zero byte position (BP) 35 on a predetermined area, or a recordable recording layer code can be recorded using a bit combination of a predetermined byte. Although the effective recording layer information is recorded at the zero BP 35 in FIG. 2, it may be recorded at a desired BP other than a zero BP. The effective recording layer information may also be recorded using a plurality of bytes instead of one byte.

Looking at the internal structure of the zero BP 35, as shown in FIG. 3, the zero BP 35 has 8 bits, that is, zero through seventh bits b0 through b7. For example, effective recording layer information regarding a disc having a dual-layer recording layer can be recorded using the seventh and sixth bits b7 and b6 as follows. For example, if the seventh and sixth bits are recorded as 00b, it represents that both the first and second recording layers L0 and L1 can be used. If they are recorded as 01b, it represents that only the first recording layer L0 can be used. If they are recorded as 10b, it represents that only the second recording layer L1 can be used. Since the dual-layer disc taken as an example does not use many bits to record effective recording layer information, the other bits are reserved.

The number of bits can be increased so as to record recording layer information regarding a disc designed in two or more layers. In other words, effective recording layer information can be recorded using at least one bit or a bit combination of a byte in a rewritable area. Additionally, a plurality of bytes instead of one byte can also be used.

As described above, effective recording layer information is recorded in a predetermined area of a rewritable data zone of at least one of a lead-in area and a lead-out area. Then, a disc drive records data in each of the recording layers of a disc in accordance with the effective recording layer information. In particular, in the above-described dual-layer disc, in case all of the recording layers set in a format are determined to be usable, the dual layer disc can be immediately forwarded to a market without extra recording of 00b.

In one implementation, the effective recording layer information can be recorded in at least one of the disc control data areas 30c-1, 30c-2, 30c-3, and 30c-4 of the disc control data zone 30c. Alternatively, the effective recording layer information can be recorded in the reserved areas 30c-5 and 30c-6. In the above, the case where recording layer information is recorded in the rewritable data zone of a lead-in area has been described. However, the recording layer information can be recorded in a rewritable data zone of a lead-out area provided on the side of the outer circumference of a storage medium.

In order to increase reliability, the effective recording layer information can be redundantly recorded in both the recordable data zones of the lead-in and lead-out areas.

Meanwhile, the optical information recording medium according to the first embodiment of the present invention records effective recording layer information in a predetermined area of the rewritable area of at least one of the lead-in and lead-out areas. The effective recording layer information can be recorded as a speed flag or code using at least one bit or a bit combination of a predetermined byte. Alternatively, a plurality of bytes can be used to record the effective recording layer information.

Although the case where the effective recording layer information is recorded in the zero BP has been described in the above, the effective recording layer information can be recorded in a BP other than the zero BP.

In a recording/reproducing method for a multi-layered optical information recording medium according to a second embodiment of the present invention, effective recording layer information is recorded in each of the bits that constitute a recordable zone of the areas other than the user data area. For example, in an optical information storage medium that is constituted of a lead-in area, a user data area, and a lead-out area and includes a plurality of recording layers, effective recording layer information is recorded in each of the bits that constitute the rewritable data zone of at least one of the lead-in area and the lead-out area. In one implementation, the effective recording layer information is recorded as data reproduced using the sum channel ch1.

For example, the effective recording layer information can be recorded in a predetermined area of the rewritable data zone 30. Here, the rewritable data zone 30 is also included in the lead-out area.

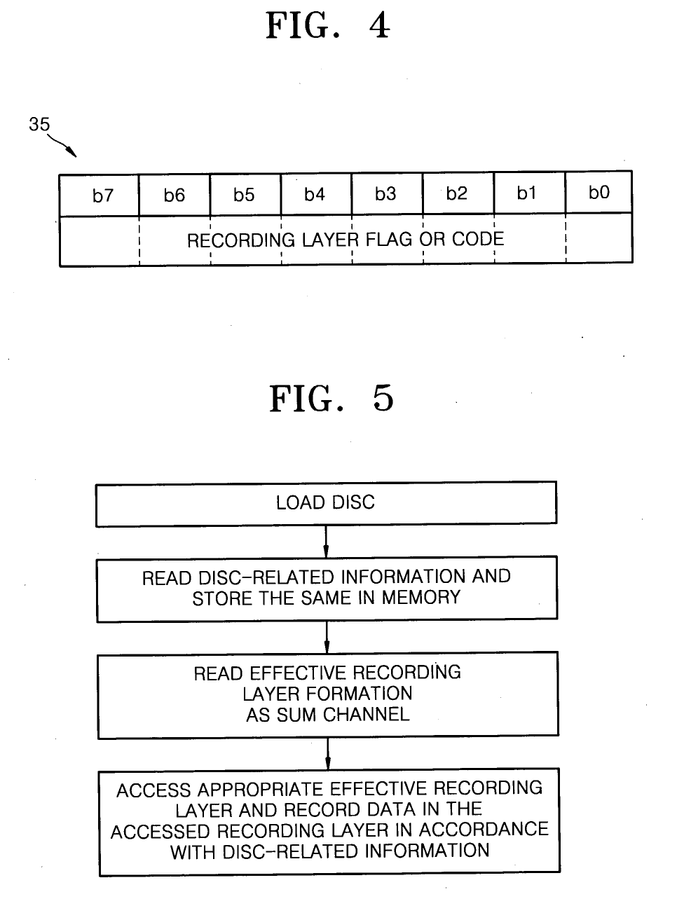

The effective recording layer information can be recorded in a predetermined area, for example, either the disc control data areas 30c-1, 30c-2, 30c-3, and 30c-4 or the reserved areas 30c-5 and 30c-6, in the rewritable data zone 30. Referring to FIG. 4, either the disc control data areas 30c-1, 30c-2, 30c-3, and 30c-4 or the reserved areas 30c-5 and 30c-6 are constituted of a plurality of bytes. Using all of 8 bits that constitute each byte, the effective recording layer information is recorded. Here, the effective recording layer information, which is data reproduced using the sum channel ch1, can be recorded in the same manner as data is recorded in the user data area.

To be more specific, each recording layer corresponds to each of the bits of a predetermined BP, and information on each of the recording layers is recorded in a corresponding bit. For example, the corresponding relationship between recording layers and bits can be prescribed as in Table 1.

TABLE 1

| Bit position (BP) | Recording layer |
|---|---|
| 7b | First recording layer |
| 6b | Second recording layer |
| 5b | Third recording layer |
| 4b | Fourth recording layer |
| 3b | Fifth recording layer |
| 2b | Sixth recording layer |
| 1b | Seventh recording layer |
| 0b | Eighth recording layer |

Referring to Table 1, all of the effective recording layers can be mentioned by recording information on each of the recording layers in a corresponding bit position. That is, if 0b is recorded in the seventh bit 7b, it represents that data can be recorded in the first recording layer. If 1b is recorded in the seventh bit 7b, it represents that data cannot be recorded in the first recording layer. If 0b is recorded in the sixth bit 6b, it represents that data can be recorded in the second recording layer. If 1b is recorded in the sixth bit 6b, it represents that data cannot be recorded in the second recording layer. The same theory is applied to the fifth through 0-th bits 5b, 4b, 3b, 2b, 1b, and 0b, so that each of the bits records information on a corresponding recording layer.

In the second embodiment, if the number of formal recording layers is 8 and only the fifth through seventh recording layers satisfy predetermined recording characteristics, effective recording layer information can be recorded as 111110001b with reference to Table 1.

In order to increase reliability, the effective recording layer information can be redundantly recorded in both the recordable data zones of the lead-in and lead-out areas.

In the first and second embodiments, since effective recording layers can all be revealed, more accurate, concrete recording layer information can be provided.

FIG. 5 is a block diagram illustrating a method of determining accessible effective recording layers in a multi-layered optical information storage medium according to the present invention. In order to record information on a disc, first, the disc is loaded on a disc drive, and a formal recording speed, which is a piece of disc-related information, is read as a sum channel ch1 or a differential signal channel ch2, which uses a push-pull signal, from a predetermined area of the disc and stored in a memory. Next, effective recording layer information is read as the sum channel ch1 from at least one area of the lead-in and lead-out areas. Finally, a pickup accesses an appropriate recording layer in accordance with the effective recording layer information read by the sum channel and performs recording. Recording conditions related to particular recording layers prescribed on the disc are provided when disc-related information corresponding to the recording conditions is read.

A speed flag or code that represents such effective recording layer information must be recorded only by a disc manufacturer and protected from being changed or erased by a disc drive after a disc is forwarded to a market.

As described above, a multi-layered optical information storage medium according to the present invention and a recording/reproducing method performed in the storage medium can utilize a disc even though all of the recording layers cannot satisfy the formal recording layer information standard due to errors occurring during the manufacture of a storage medium. In particular, the necessity of the present invention has increased with the recent trend toward a higher recording capacity.

In a multi-layered optical information storage medium according to the present invention and a recording/reproducing method for the same, the proportion of discs that are discarded due to defects can be reduced, and loss of user data due to application of inaccurate recording layer information can be prevented.

Although a few preferred embodiments of the present invention have been shown and described, it would be appreciated by those skilled in the art that changes may be made in these embodiments without departing from the principles and spirit of the invention, the scope of which is defined in the claims and their equivalents.

1. A multi-layered optical information storage medium, comprising:
a plurality of recording layers, wherein formal recording layer information is recorded in a reproduction-only area, and effective recording layer information is recorded in a recordable zone of an area other than a user data area.

2. The multi-layered optical information storage medium of claim 1, wherein the formal recording layer information is recorded as data that is reproduced using a differential signal channel.

3. The multi-layered optical information storage medium of claim 2, wherein the data that is reproduced using a differential signal channel is recorded in a high-frequency wobble.

4. The multi-layered optical information storage medium of claim 3, wherein the effective recording layer information includes data that is reproduced using a sum channel.

5. The multi-layered optical information storage medium of claim 4, wherein the multi-layered optical information storage medium comprises a lead-in area, the user data area, and a lead-out area, and
the effective recording layer information is recorded in a rewritable data zone of at least one of the lead-in area and the lead-out area.

6. The multi-layered optical information storage medium of claim 5, wherein the effective recording layer information is redundantly recorded in the rewritable data zones of the lead-in and lead-out areas.

7. The multi-layered optical information storage medium of claim 6, wherein the rewritable data zone includes a disc control data zone that has at least one disc control data area in which disc control data is recorded and a reserved area, and the effective recording layer information is recorded in any of the at least one disc control data area and the reserved area.

8. The multi-layered optical information storage medium of claim 4, wherein the effective recording layer information is recorded as a recording layer flag or code using at least one bit or a bit combination of a predetermined byte in a rewritable data zone.

9. The multi-layered optical information storage medium of claim 4, wherein the effective recording layer information is recorded in each of the bits of a byte present in a rewritable data zone such that information on each of the recordable recording layers corresponds to each of the bits.

10. The multi-layered optical information storage medium of claim 1, wherein the formal recording layer information is recorded in a pit that is reproduced using a sum channel.

11. The multi-layered optical information storage medium of claim 10, wherein the effective recording layer information is recorded as data that is reproduced using the sum channel.

12. The multi-layered optical information storage medium of claim 11, wherein the multi-layered optical information storage medium comprises a lead-in area, a user data area, and a lead-out area; and
the effective recording layer information is recorded in a rewritable data zone of at least one of the lead-in area and the lead-out area.

13. The multi-layered optical information storage medium of claim 12, wherein the effective recording layer information is redundantly recorded in the rewritable data zones of the lead-in and lead-out areas.

14. The multi-layered optical information storage medium of claim 13, wherein the rewritable data zone includes a disc control data zone that has at least one disc control data area in which disc control data is recorded and a reserved area, and the effective recording layer information is recorded in any of the at least one disc control data area and the reserved area.

15. The multi-layered optical information storage medium of claim 14, wherein the effective recording layer information is recorded as a recording layer flag or code using at least one bit or a bit combination of a predetermined byte in the rewritable data zone.

16. The multi-layered optical information storage medium of claim 14, wherein the effective recording layer information is recorded in each of the bits of a byte present in the rewritable data zone such that information on each of the recordable recording layers corresponds to each of the bits.

17. The multi-layered optical information storage medium of claim 1, wherein the effective recording layer information is recorded as data that is reproduced using a sum channel.

18. A method of recording/reproducing data in/from an optical information storage medium that includes a lead-in area, a user data area, and a lead-out area and has a plurality of recording layers, the method comprising:
recording formal recording layer information in a reproduction-only data zone of at least one of the lead-in area and the lead-out area;
recording effective recording layer information in a rewritable data zone of at least one of the lead-in area and the lead-out area;
accessing an appropriate effective recording layer in accordance with the effective recording layer information; and
recording data in the accessed effective recording layer.

19. The recording/reproducing method of claim 18, wherein the formal recording layer information is recorded as data that is reproduced using a differential signal channel.

20. The recording/reproducing method of claim 19, wherein the data that is reproduced using the differential signal channel is recorded in a high-frequency wobble.

21. The recording/reproducing method of claim 19, wherein the effective recording layer information comprises data that is reproduced using a sum channel.

22. The recording/reproducing method of claim 19, wherein the rewritable data zone comprises:
a disc control data zone that has at least one disc control data area in which disc control data is recorded and a reserved area; and
the effective recording layer information is recorded in any of the at least one disc control data area and the reserved area.

23. The recording/reproducing method of claim 19, wherein the effective recording layer information is recorded as a recording layer flag or code using at least one bit or a bit combination of a predetermined byte in the rewritable data zone.

24. The recording/reproducing method of claim 18, wherein the formal recording layer information is recorded in a pit that is reproduced using a sum channel.

25. The recording/reproducing method of claim 24, wherein the effective recording layer information is recorded as data that is reproduced using the sum channel.

26. The recording/reproducing method of claim 25, wherein the effective recording layer information is redundantly recorded in the rewritable data zones of the lead-in and lead-out areas.

27. The recording/reproducing method of claim 26, wherein the rewritable data zone comprises:
a disc control data zone that has at least one disc control data area in which disc control data is recorded and a reserved area;
wherein the effective recording layer information is recorded in any of the at least one disc control data area and the reserved area.

28. The recording/reproducing method of claim 25, wherein the effective recording layer information is recorded as a recording layer flag or code using at least one bit or a bit combination of a predetermined byte in the rewritable data zone.

29. The recording/reproducing method of claim 25, wherein the effective recording layer information is recorded in each of the bits of a byte present in the rewritable data zone so that information on each of the recordable recording layers corresponds to each of the bits.

30. The recording/reproducing method of claim 18, wherein the effective recording layer information is recorded as data that is reproduced using a sum channel.

31. A method of accessing effective recording layers of a multi-layered optical disc, the method comprising:
reading effective recording layer information indicative of reproducibility of layers of the of the optical disc from a lead-in area and/or a lead-out area of the multi-layered optical disc; and
accessing an appropriate recording layer in accordance with the effective recording layer information.

32. The method of claim 31, further comprising:
loading the optical disc in an optical disc drive to read the effective recording layer information.

33. The method of claim 32, further comprising:
reading disc-related information from the loaded disc, the disc-related information comprising optical media specifications.

34. The method of claim 33, further comprising:
storing the read disc-related information and the effective recording layer information.

35. The method of claim 33, wherein the disc-related information comprises a recording speed of the optical disc.

36. The method of claim 35, further comprising:
operating the disc at the recording speed.
